(19) United States
(12) Patent Application Publication
(10) Pub. No.: US 2025/0271863 A1
(43) Pub. Date: Aug. 28, 2025

(54) LOCATION INFORMATION SYSTEM

(71) Applicant: Kawasaki Jukogyo Kabushiki Kaisha, Kobe-shi (JP)

(72) Inventors: Takumi OHASHI, Kobe-shi (JP); Junki MATSUO, Kobe-shi (JP); Yoshitaka MURAMATSU, Kobe-shi (JP)

(73) Assignee: Kawasaki Jukogyo Kabushiki Kaisha, Kobe-shi (JP)

(21) Appl. No.: 19/067,130

(22) Filed: Feb. 28, 2025

(30) Foreign Application Priority Data
Feb. 28, 2024 (JP) 2024-028983

(51) Int. Cl. G05D 1/622; G05D 1/246; G05D 1/65; G05D 107/70; G05D 111/30; H04W 4/02; H04W 4/40; H04W 4/80

(52) U.S. Cl. CPC G05D 1/622; G05D 1/246; G05D 1/65; H04W 4/025; H04W 4/40; H04W 4/80; G05D 2107/70; G05D 2111/32

(57) ABSTRACT

A location information system includes: an autonomous mobile robot that has map data of a specific area and a sensor configured to estimate a location of a vehicle by detecting surrounding condition and that is configured to travel in the specific area; a communication terminal to be carried by a person in the specific area; and a location information providing portion that is configured to provide the autonomous mobile robot with information regarding a location of the person based on short-range wireless communication with the communication terminal.

### CROSS-REFERENCE TO RELATED APPLICATIONS

This application is based on and claims priority under 35 USC § 119 from Japanese Patent Application No. 2024-028983 filed on Feb. 28, 2024, the contents of which are incorporated herein by reference.

### TECHNICAL FIELD

The technology disclosed herein relates to a location information system.

### BACKGROUND

Patent Literature 1 discloses a control device for an automated guided vehicle in the related art. The control device for an automated guided vehicle includes an automatic guided vehicle (AGV). The control device for an automated guided vehicle is applied to a plant where workers and AGVs work in the same place. The AGV travels along a predetermined travel route. The control device for an automated guided vehicle is equipped with a fisheye camera mounted on the ceiling. The control device for an automated guided vehicle obtains a distance along the AGV's travel route between the worker and the AGV based on image data from the fisheye camera, and calculates the degree of danger posed by the AGV to the worker based on the obtained distance. The control device for an automated guided vehicle controls the speed of the AGV based on the calculated degree of danger.

Patent Literature 1: JP2021-140638A

The travel route of the AGV is determined in advance. The control device for an automated guided vehicle in the related art is capable of obtaining a distance between the workers and the AGVs along the travel route because the travel route is determined in advance.

The travel route of an autonomous mobile robot (hereinafter, AMR) is not determined in advance. It is difficult to apply the control device for an automated guided vehicle in the related art to a robot system equipped with an AMR.

### SUMMARY

A location information system includes: an autonomous mobile robot that has map data of a specific area and a sensor configured to estimate a location of a vehicle by detecting surrounding condition and that is configured to travel in the specific area; a communication terminal to be carried by a person in the specific area; and a location information providing portion that is configured to provide the autonomous mobile robot with information regarding a location of the person based on short-range wireless communication with the communication terminal.

### BRIEF DESCRIPTION OF DRAWINGS

FIG. 1 illustrates a portion of an automobile manufacturing plant to which a location information system is applied.

FIG. 2 illustrates a work area where work is performed on a workpiece.

FIG. 3 is a block diagram of a robot system including a location information system.

FIG. 4 is a block diagram of an AMR.

FIG. 5 illustrates information exchange in a location information system.

FIG. 6 illustrates map data with AMR locations and people locations added.

FIG. 7 is a flowchart showing travel control of the AMR.

FIG. 8 illustrates a modification of the location information system.

FIG. 9 illustrates another modification of the location information system.

FIG. 10 illustrates still another modification of the location information system.

FIG. 11 illustrates still another modification of the location information system.

### DESCRIPTION OF EMBODIMENTS

Hereinafter, an embodiment of a location information system will be described with reference to the drawings. The location information systems described herein are exemplary.

### Overall Structure of Robot System

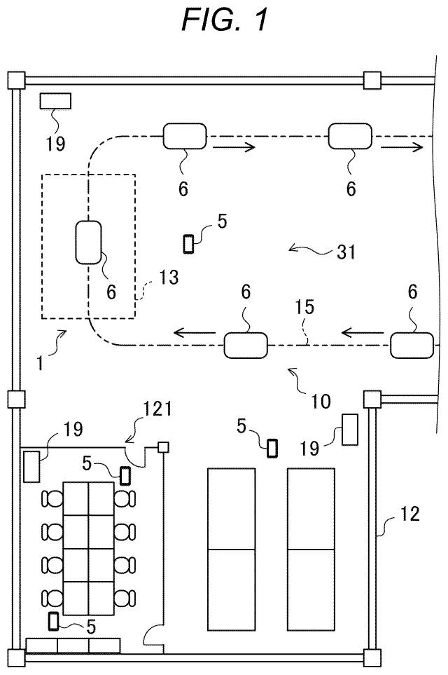

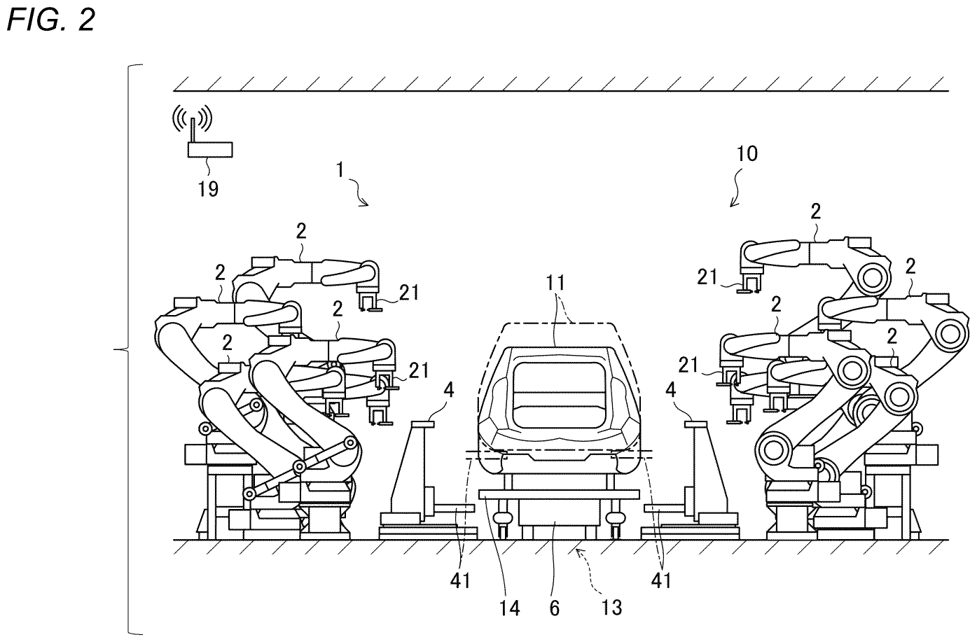

FIG. 1 illustrates a portion of an automobile manufacturing plant to which a location information system is applied. FIG. 2 illustrates a work area 13 in a manufacturing plant where work is carried out on a workpiece. A manufacturing line 10 is provided in a building 12 of the manufacturing plant. The illustrated manufacturing line 10 is a line where welding, more specifically spot welding, is performed on an automobile body 11. The workpiece is the body 11. In the manufacturing line 10, the body 11 is transported by an AMR 6, which will be described later. The work area 13 refers to an area where the workpiece transported by the AMR 6 stays to receive work. The work area 13 is a portion of the manufacturing line 10.

In the work area 13, a robot system 1 is constructed. The robot system 1 performs spot welding on the body 11 in the work area 13.

The robot system 1 includes a robot 2. The robot 2 performs work on the workpiece transported to the work area 13. The work performed by the robot 2 on the body 11 is welding.

The robot 2 is a vertical articulated robot having five to seven axes. As illustrated in FIG. 2, the robot 2 includes a welding gun 21 as an end effector. The robot 2 is not limited to the vertical articulated robot.

The robot system 1 includes a plurality of robots 2. The plurality of robots 2 are located on each of both of a left and right sides of the body 11 of the automobile. On the right side of the body 11, the plurality of robots 2 are lined up in a front-rear direction of the body 11. Similarly, on the left side of the body 11, the plurality of robots 2 are lined up in the front-rear direction of the body 11. Each robot 2 performs welding at a different position on the body 11. The number of robots 2 in the robot system 1 is not limited to a specific number. Furthermore, the arrangement of the robot 2 in the robot system 1 is not limited to a specific arrangement.

The robot system 1 is equipped with a plurality of locators 4. The plurality of locators 4 are located on each of both of the left and right sides of the body 11. As indicated by the dashed line in FIG. 2, the locator 4 lifts and supports the body 11 while the robot 2 is working. The locator 4 in the illustrated example is a three-axis orthogonal robot. The locator 4 includes a rod 41 that engages with the body 11. The rod 41 extends horizontally. A tip end of the rod 41 engages with the body 11. The locator 4 changes the location of the tip end of the rod 41 back and forth, left and right, and up and down.

The robot system 1 includes one or more transport vehicles. The transport vehicle transports the workpiece to the work area 13. The transport vehicle is an autonomous mobile robot (AMR) 6. The AMR 6 travels on a flat floor of the plant. A route 15 of the AMR 6 is not determined in advance, but an approximate route is determined as shown by the two-dot chain line in FIG. 1.

As illustrated in FIG. 2, the body 11 is placed on a carriage 14. The AMR 6 is located below the carriage 14 and engages with the carriage 14. The AMR 6 transports the body 11 with the carriage 14. Incidentally, the AMR 6 may directly support the body 11 without using the carriage 14. It should be noted that the external appearance of the AMR 6 illustrated in FIG. 2 is an example. The structure of the AMR 6 will be described later.

An office 121 is provided in a portion of the building 12 of the manufacturing plant. The office 121 is separated from the manufacturing line 10 by a partition. While the manufacturing line 10 is in operation, people are present in the office 121. While the manufacturing line 10 is operating normally, basically, no person enters the manufacturing line 10. When an abnormality occurs in the manufacturing line 10, a person may enter the manufacturing line 10.

In the building 12, a person carries a communication terminal 5. When the person moves, the communication terminal 5 also moves. The communication terminal 5 has a short-range wireless communication function. The short-range wireless communication is Wi-Fi (registered trademark), Bluetooth (registered trademark), or both Wi-Fi and Bluetooth. The communication terminal 5 may be, for example, a smartphone. The communication terminal 5 may be a dedicated terminal for a location information system 31. As described below, the communication terminal 5 is used in the location information system 31 to acquire location information of a person.

The location information system 31 is a system that manages the locations of people and AMRs 6 within the building 12. The location information system 31 is included in the robot system 1.

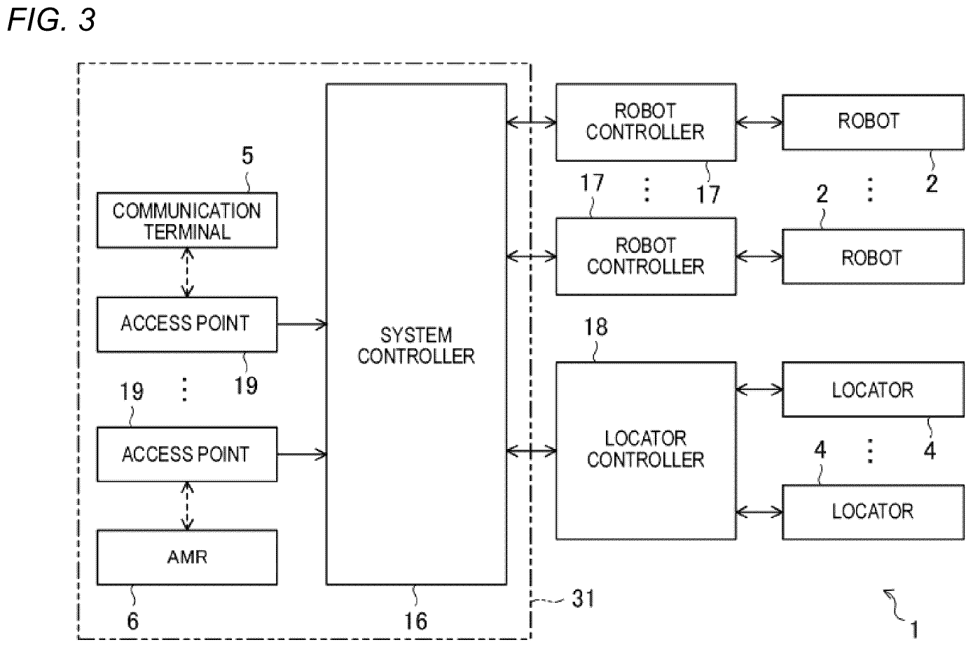

FIG. 3 is a block diagram of the robot system 1 and the location information system 31. The robot system 1 includes a system controller 16. The system controller 16 controls the entire robot system 1.

The robot system 1 includes a robot controller 17. It should be noted that the robot controller 17 is not an essential element of the robot system 1. The robot controller 17 is electrically connected to the system controller 16. The electrical connection may be a wired or wireless connection. The robot controller 17 is also electrically connected to the robot 2. The robot controller 17 and the robot 2 are connected in a one-to-one relationship. The robot system 1 includes the robot controllers 17 in the same number as the robots 2.

The robot controller 17 controls the robot 2. More specifically, the robot controller 17 receives a control signal from the system controller 16 and outputs a control signal to the robot 2. The robot 2 receives the control signal from the robot controller 17 and performs welding work on the body 11 here.

The robot system 1 includes a locator controller 18. The locator controller 18 is electrically connected to the system controller 16. The electrical connection may be a wired or wireless connection. The locator controller 18 is also electrically connected to the plurality of locators 4.

The locator controller 18 controls the locator 4. More specifically, the locator controller 18 receives a control signal from the system controller 16 and outputs a control signal to the locator 4. The locator 4 receives the control signal from the locator controller 18 and positions and supports the body 11 delivered from the AMR 6 at a predetermined location.

The robot system 1 is equipped with an access point 19. The access point 19 is an access point for Wi-Fi. The communication terminal 5 or the AMR 6 can communicate with the access point 19.

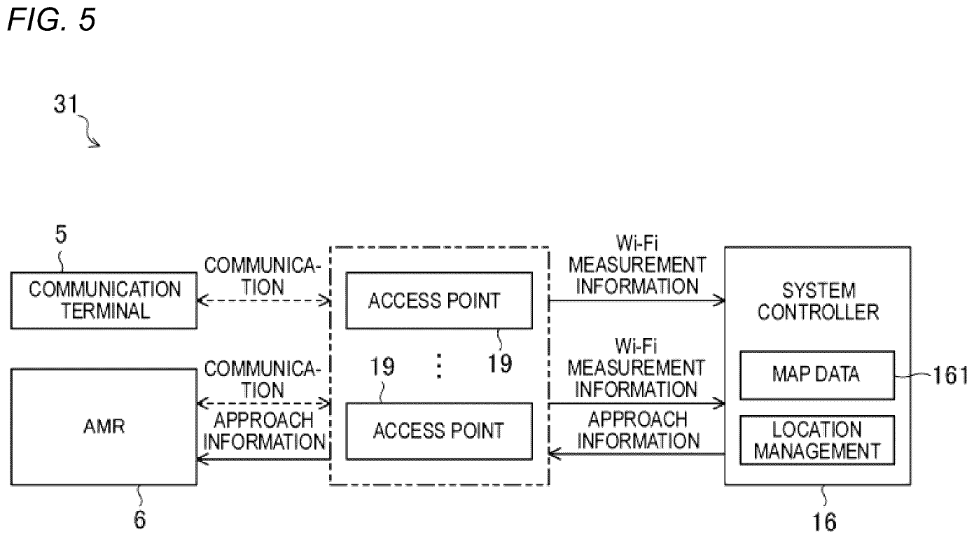

The robot system 1 has a plurality of access points 19. As illustrated in FIG. 1 or FIG. 2, the plurality of access points 19 are installed in various positions in the building 12. The locations of the plurality of access points 19 in the building 12 are fixed. The communication terminal 5 or the AMR 6 located in the building 12 is connected to one or more access points 19. As illustrated in FIG. 5, when the access point 19 communicates with the communication terminal 5 or the AMR 6, the access point outputs Wi-Fi measurement information to the system controller 16. The Wi-Fi measurement information is information on radio wave intensity related to the distance between the access point 19 and the communication terminal 5 or the distance between the access point 19 and the AMR 6. As described below, the location information system 31 is able to determine the location of the communication terminal 5 or the AMR 6 in the building 12 based on the Wi-Fi measurement information acquired by the access point 19 and the location information of the access point 19.

In addition to the function of transmitting the Wi-Fi measurement information described above, the access point 19 also functions as a repeater that connects the communication terminal 5 or the AMR 6 to the communication network.

### Structure of AMR

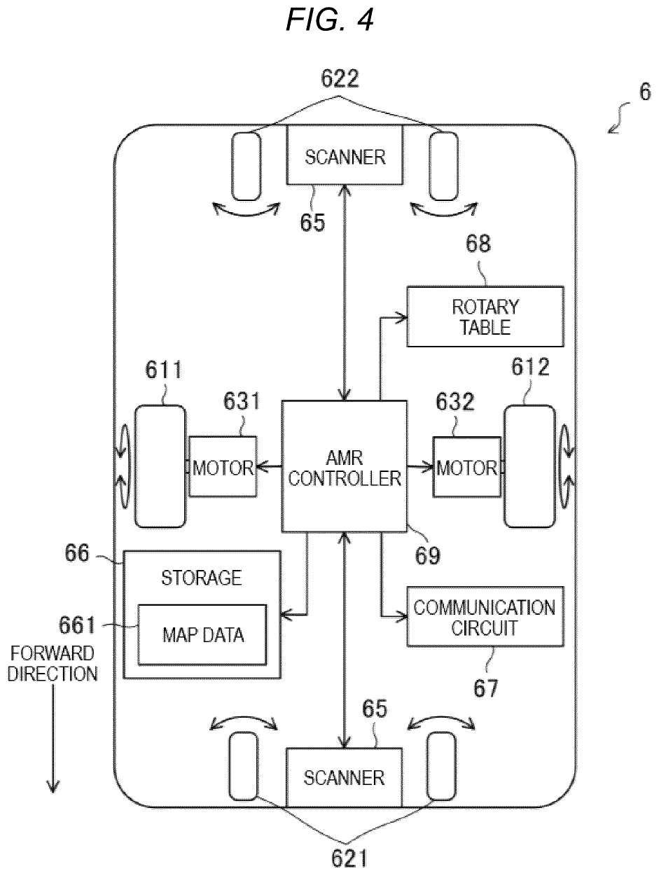

FIG. 4 illustrates the structure of the AMR 6. The structure of the AMR 6 in FIG. 4 is an example of the AMR 6.

The AMR 6 includes a plurality of wheels that roll on the floor surface. The wheels include two driving wheels 611 and 612 and driven wheels 621 and 622.

The two driving wheels 611 and 612 are independent. The AMR 6 is an independently driven transport vehicle. The driving wheel 611 is located on the right of an intermediate part of the AMR 6 in the front-rear direction. The driving wheel 612 is located on the left of the intermediate part of the AMR 6. Rotation shafts of the driving wheels 611 and 612 extend in a left-right direction and are coaxial.

The driving wheel 611 is mechanically connected to a motor 631. The driving wheel 612 is mechanically connected to a motor 632. The driving wheels 611 and 612 can rotate independently of each other.

The motors 631 and 632 are driven by power supplied from a battery. The battery is installed in the AMR 6. The motors 631 and 632 are travel driving sources for the AMR 6. Driving forces of the motors 631 and 632 are transmitted to the driving wheels 611 and 612, causing the driving wheels 611 and 612 to rotate.

If the driving wheels 611 and 612 rotate in the same direction at the same rotation speed, the AMR 6 moves straight. If the driving wheels 611 and 612 rotate in the same direction at different rotation speeds, the AMR 6 changes a travel direction thereof.

If the driving wheels 611 and 612 rotate in opposite directions, the AMR 6 turns in place, that is, rotates about a vertical axis. When the driving wheel 611 rotates in a forward direction and the driving wheel 612 rotates in a reverse direction, the AMR 6 rotates counterclockwise in FIG. 4. When the driving wheel 611 rotates in the reverse direction and the driving wheel 612 rotates in the forward direction, the AMR 6 rotates in the clockwise direction in FIG. 4.

The driven wheel 621 is located at the center in the left-right direction of a front end portion of the AMR 6. The driven wheel 622 is located at the center in the left-right direction of a rear end portion of the AMR 6. Each of the driven wheels 621 and 622 is capable of changing direction. Alternatively, the AMR 6 may include one driven wheel.

The AMR 6 includes a scanner 65. The scanner 65 acquires information about surroundings of the AMR 6. The scanner 65 includes, for example, light detection and ranging (LiDAR). The scanner 65 is not limited to the LiDAR. The scanner 65 is located at both the front and rear end portions of the AMR 6.

The AMR 6 includes a storage 66. The storage 66 stores various data. The data stored in the storage 66 includes map data 661. The map data 661 is map data of the inside of the building 12 including the manufacturing line 10. Before transporting the body 11, the AMR 6 autonomously travels within the building 12 and creates map data 661 using the scanner 65 while traveling. The AMR 6 may acquire the map data 661 created in advance from an external portion.

The AMR 6 includes a communication circuit 67. The communication circuit 67 performs wireless communication with the access point 19 via Wi-Fi. The communication circuit 67 is capable of receiving a control signal from the system controller 16. The communication circuit 67 can transmit, for example, location information of the AMR 6 to the system controller 16.

The AMR 6 has a rotary table 68. The rotary table 68 is located on the upper surface of the AMR 6. The rotary table 68 engages with the body 11 via the carriage 14. The rotary table 68 rotates in both a clockwise and counterclockwise directions about a vertical axis. The rotary table 68 rotates relative to the body of the AMR 6. The rotary table 68 has a driving source. The driving source is, for example, an electric motor. The electric motor may include a servo motor or a stepping motor. More specifically, the rotary table 68 includes a rotary motor that rotates the rotary table 68 about a vertical axis, and a lifting motor that raises and lowers the rotary table 68. When the rotary table 68 rotates while the AMR 6 is stationary, the body 11 rotates about the vertical axis via the carriage 14. The body 11 can rotate on the spot without moving in the front-rear direction and left-right directions. The AMR 6 rotates in place by driving of the driving wheels 611 and 612, and the rotary table 68 also rotates, so that the orientation of the AMR 6 can be changed without changing the orientation of the body 11.

The AMR 6 has an AMR controller 69. The AMR controller 69 controls the AMR 6. The AMR controller 69 is electrically connected to the motors 631 and 632, the scanner 65, the storage 66, the communication circuit 67, and the rotary table 68.

During the creation of the map data 661, the AMR controller 69 creates the map data 661 based on the signal from the scanner 65 while outputting control signals to the motors 631 and 632 to drive the AMR 6. The AMR controller 69 stores the created map data 661 in the storage 66.

The AMR controller 69 receives a control signal from the system controller 16 via the communication circuit 67, and causes the AMR 6 to execute an operation according to the received control signal. The AMR 6 travels to a location specified by the system controller 16, that is, to the work area 13 of the robot 2. When the AMR 6 travels, the AMR controller 69 sets the route 15 for the AMR 6 based on the map data 661. While the AMR 6 is traveling, the AMR controller 69 determines the location of the vehicle of the AMR 6 based on the signal from the scanner 65 and the map data 661. The AMR 6 autonomously travels to the work area 13 along the route 15, and the body 11 is transported to the work area 13.

### Configuration of Location Information System

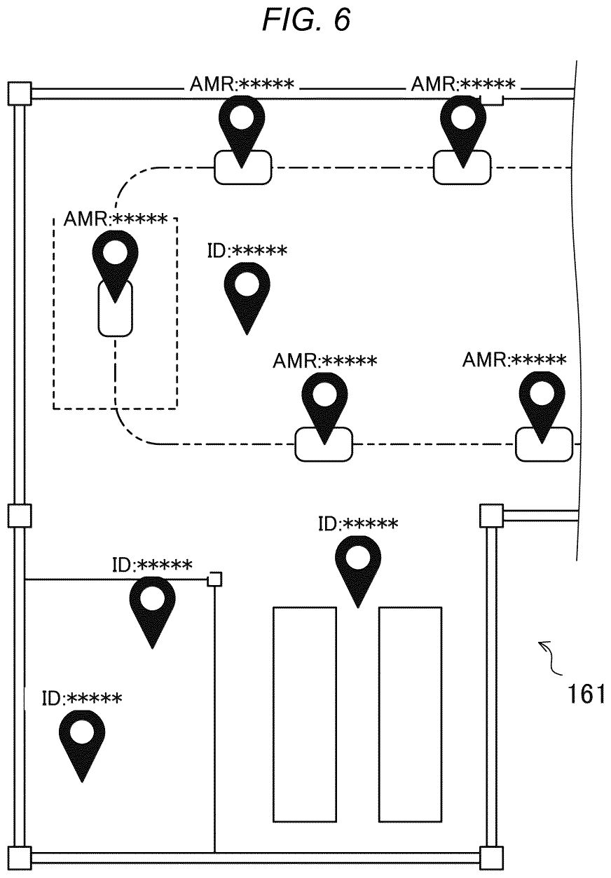

FIG. 5 illustrates a block diagram of the location information system 31. The location information system 31 includes the system controller 16. It should be noted that the system controller 16 is not an essential element of the location information system 31. The system controller 16 has the function of managing the locations of people in the building 12 and the locations of the AMRs 6. In the location information system 31 of FIG. 5, the system controller 16 has map data 161. For example, FIG. 6 illustrates an example of the map data 161 stored in the system controller 16. The map data 161 is map data of the building 12. The map data 161 is substantially the same as the map data 661 of the AMR 6. The system controller 16 may be provided with map data from the AMR 6.

The location information system 31 includes an access point 19. It should be noted that the access point 19 is not an essential element of the location information system.

The location information system 31 includes a communication terminal 5. The communication terminal 5 is carried by a person. In the building 12, the locations of people and the locations of the communication terminals 5 coincide with each other. As described above, the communication terminal 5 communicates with the access point 19 via Wi-Fi.

The location information system 31 is equipped with the AMR 6. The AMR 6 also communicates with the access point 19 via Wi-Fi.

Next, the operation of the location information system 31 will be described. The communication terminal 5 or the AMR 6 present in the building 12 each communicates with the access point 19. The access point 19 provides Wi-Fi measurement information to the system controller 16.

The system controller 16 determines the location of the communication terminal 5 or AMR 6 present in the building 12 based on the Wi-Fi measurement information from the access point 19. More specifically, the Wi-Fi measurement information is related to the distance between the access point 19 and the communication terminal 5 or the distance between the access point 19 and the AMR 6. The system controller 16 can determine the location of the communication terminal 5 or AMR 6 present in the building 12 based on the Wi-Fi measurement information from the access point 19 and location information of the access point 19 in the building 12. As illustrated in FIG. 6, the map data 161 in the system controller 16 includes the location of the communication terminal 5 and the location of the AMR 6. In FIG. 6, the location of the communication terminal 5 is indicated by “ID: *****”, and the location of the AMR 6 is indicated by “AMR: *” The system controller 16 distinguishes between the communication terminal 5 and the AMR 6.

As a person moves around in the building 12, the location of the communication terminal 5 changes. Similarly, as the AMR 6 travels, the location of the AMR 6 changes. The access point 19 updates the Wi-Fi measurement information. The system controller 16 constantly monitors the location of the communication terminal 5 and the location of the AMR 6 based on the updated Wi-Fi measurement information.

When the distance between the location of the communication terminal 5 and the location of the AMR 6 becomes equal to or shorter than a first distance, the system controller 16 determines that the person and the AMR 6 have approached each other, and transmits approach information to the AMR 6 via the access point 19. When the AMR 6 during the traveling receives the approach information, the AMR 6 decelerates. By decelerating the AMR 6, contact between the person and the AMR 6 is avoided. Furthermore, when the distance between the location of the communication terminal 5 and the location of the AMR 6 becomes equal to or shorter than a second distance, the system controller 16 determines that the person and the AMR 6 have approached each other, and transmits closest approach information to the AMR 6 via the access point 19. When the AMR 6 during the traveling receives the closest approach information, the AMR 6 stops. By stopping the AMR 6, contact between the person and the AMR 6 is avoided. The second distance is shorter than the first distance. The approach information and closest approach information are examples of information regarding the location of the person in a specific area. For example, the first distance is the range between 500 mm and 5000 mm and the second distance is the range between 10 mm and 500 mm.

Incidentally, the system controller 16 does not transmit the approach information or closest approach information even if people approach each other. Furthermore, the system controller 16 may be configured not to transmit the approach information or closest approach information even if the AMRs 6 approach each other. This is because the AMR 6 can recognize the approach of other AMRs 6 based on the measurement signal of the scanner 65. The system controller 16 may transmit the approach information or closest approach information when the AMRs 6 approach each other.

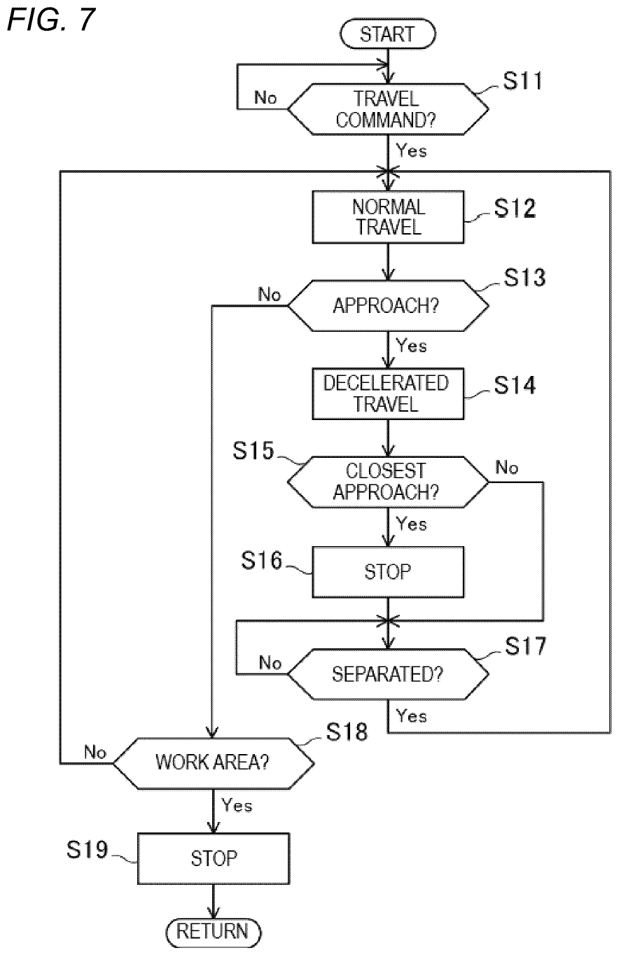

FIG. 7 is a flowchart showing travel control of the AMR 6. In the flow of FIG. 7, the order of steps can be changed, some steps can be omitted, and other steps can be added, to the extent possible.

In step S11 after starting, the AMR 6 determines whether or not a travel command has been received from the system controller 16. The AMR 6 remains stopped until a travel command is received. If the travel command is received, the AMR 6 travels normally in step S12. Normal travelling here means travelling at a set speed.

In step S13, the AMR 6 determines whether or not the approach information has been received from the system controller 16. If the approach information has not been received, the AMR 6 determines in step S18 whether or not the AMR 6 has arrived at the work area 13. If the AMR 6 has not arrived at the work area 13, the AMR 6 continues normal travelling in step S12. When the AMR 6 arrives at the work area 13, the AMR 6 stops in step S19. After the AMR 6 stops, the locator 4 supports the body 11 and the robot 2 performs welding of the body.

While the robot 2 is performing welding, the AMR 6 waits for a travel command from the system controller 16 in step S11.

When the AMR 6 is travelling normally, if the AMR 6 receives approach information from the system controller 16 in step S13, the AMR 6 decelerates in step S14. The travel speed of the AMR 6 becomes lower than the set speed. Furthermore, if the AMR 6 receives the closest approach information from the system controller 16 in step S15, the AMR 6 stops in step S16. In step S17, the AMR 6 determines whether or not separation information, that is, information indicating that the person and the AMR 6 have separated, has been received from the system controller 16. Until the AMR 6 receives the separation information, the AMR 6 continues to decelerate or remains stopped. If the separation information is received, the AMR 6 resumes normal travelling in step S12. When the distance between the location of the communication terminal 5 and the location of the AMR 6 becomes equal to or longer than a third distance, the system controller 16 may determine that the person and the AMR 6 have separated from each other, and may transmit separation information to the AMR 6 via the access point 19. The third distance may be the same as the first distance or may be greater than the first distance. For example, the third distance is the range between 5000 mm and 10000 mm.

Furthermore, when the system controller 16 transmits the approach information to the AMR 6 in step S13 or transmits the closest approach information in step S15, the system controller 16 may also transmits the approach information or closest approach information to the communication terminal 5 related to the approach information. The communication terminal 5 that receives the approach information or closest approach information may notify a person of the approach information or closest approach information.

### Operation and Effect

The AMR 6 does not require a travelling guide. As illustrated in FIG. 2, the manufacturing line 10 equipped with the AMR 6 has the advantage that it does not require pits required in the manufacturing lines in the related art, that is, the pits for laying body transporting rails and a body elevator. In addition, since the floor surface of the building 12 is flat, the manufacturing line 10 equipped with the AMR 6 has the advantage of being easily adaptable to layout changes.

Furthermore, using the AMR 6 in the manufacturing line 10 makes it possible to adjust production by adjusting the number of AMRs 6. A flexible operation of the manufacturing line 10 is realized.

In the manufacturing line 10 along which the AMR 6 travels, there is no predetermined route 15, and the floor surface of the building 12 is flat. The people can travel on the route 15 of the AMR 6. For example, if the person enters the manufacturing line 10 when an abnormality occurs, there is a risk that he or she may come into contact with the AMR 6.

The location information system 31 manages the location of the person and the location of the AMR 6 based on the short-range wireless communication, so that contact between the person and the AMR 6 can be suppressed. The safety in plants is improved. The system controller 16 is an example of a location information providing portion that provides the approach information or closest approach information to the AMR 6 as information relating to the location of the person.

Here, the AMR 6 includes the scanner 65, so that the AMR can detect obstacles in the surroundings and avoid contact with people. However, the person enters the manufacturing line 10 only when the abnormality occurs or when something is not normal. It is also possible that a person performing work to resolve an abnormality may be outside the detection range of the scanner 65, or that the tools used for the work may be outside the detection range of the scanner 65. In addition to the scanner 65 of the AMR 6, the location information system 31 manages the location of the person and the location of the AMR 6 using the short-range wireless communication, which further reduces contact between the person and AMR 6. The location information system 31 further improves safety in the plant.

### Modification 1 of Location Information System

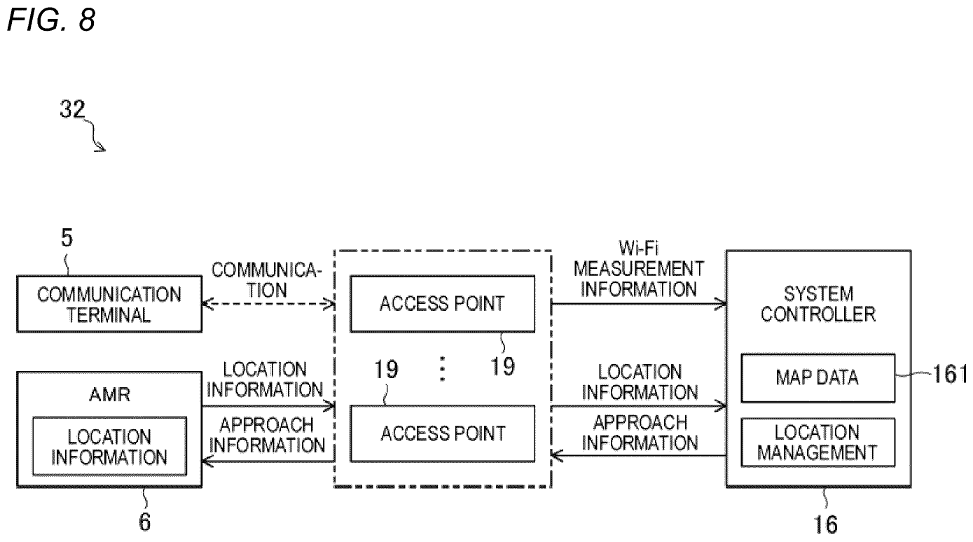

FIG. 8 illustrates a location information system 32 according to a modification. In the location information system 32, the location of the AMR 6 is acquired by the AMR 6 itself. The location of the AMR 6 is not limited to being acquired using the short-range wireless communication between the AMR 6 and the access point 19.

As described above, the AMR 6 uses the map data 661 and the scanner 65 to determine the location of the vehicle. The AMR 6 transmits the location information of the vehicle to the system controller 16 via the access point 19 at any time. The location information of the communication terminal 5 is acquired based on Wi-Fi measurement information obtained by the short-range wireless communication between the communication terminal 5 and the access point 19.

The system controller 16 constantly monitors the location of the communication terminal 5 and the location of the AMR 6 in the same manner as described above. The system controller 16 transmits the approach information or closest approach information to the AMR 6 based on the distance between the location of the communication terminal 5 and the location of the AMR 6. The AMR 6 executes travel control in accordance with the flowchart of FIG. 7.

### Modification 2 of Location Information System

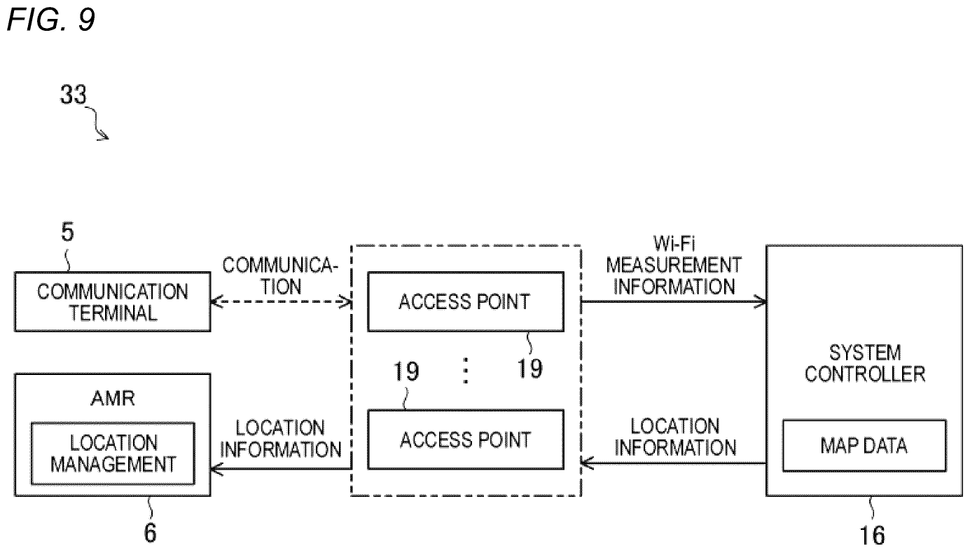

FIG. 9 illustrates a location information system 33 according to a modification. In the location information system 33, the AMR 6 monitors the location of the communication terminal 5 and the location of the AMR 6 instead of the system controller 16.

In the location information system 33, the location of the communication terminal 5 is acquired by the short-range wireless communication with the access point 19. The system controller 16 transmits the location information of the communication terminal 5 to the AMR 6. The system controller 16 is an example of a location information providing portion that provides the AMR 6 with location information of the communication terminal 5 as information regarding the location of a person.

The AMR 6 can acquire the location information of the communication terminal 5 and the location information of the vehicle from the system controller 16. The AMR 6 constantly monitors the location of the communication terminal 5 and the location of the AMR 6 in the map data 661. The AMR 6 can detect the location of a person and the location of the vehicle by methods other than detection by the scanner 65. The AMR 6 can suppress contact with the person by using two different methods.

The AMR 6 executes travel control in accordance with the flowchart of FIG. 7. In step S13 of the flow in FIG. 7, the AMR 6 does not determine whether or not the AMR has received the approach information from the system controller 16, but determines whether or not the person being monitored and the vehicle have approached each other based on the location of the person and the location of the vehicle. In step S15, the AMR 6 determines whether or not the person being monitored and the vehicle have approached closest to each other based on the location of the person and the location of the vehicle. In step S17, the AMR 6 further determines whether or not the person being monitored and the vehicle have separated from each other based on the location of the person and the location of the vehicle.

### Modification 3 of Location Information System

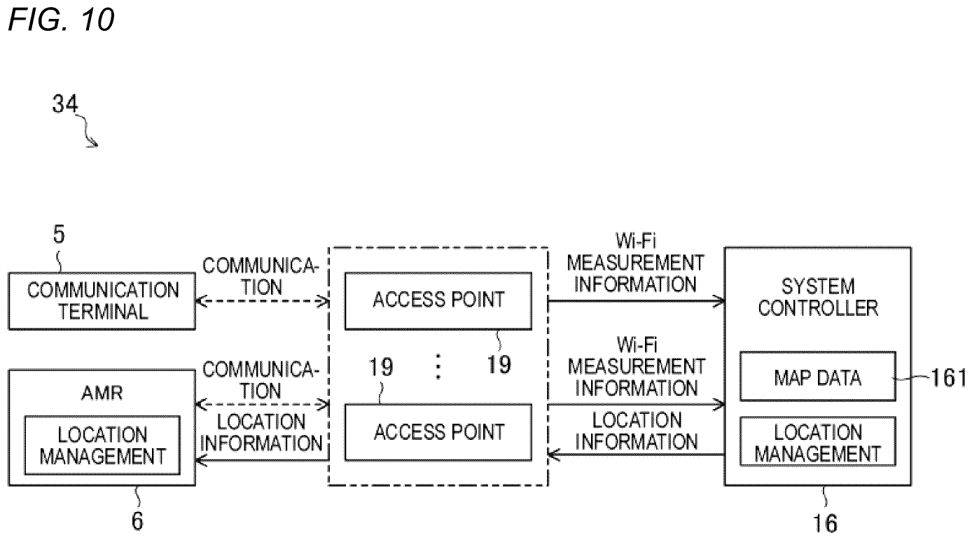

FIG. 10 illustrates a location information system 34 according to a modification. The location information system 34 is a combination of the location information system 31 of FIG. 5 and the location information system 33 of FIG. 9. That is, the location information of the AMR 6 is acquired by the short-range wireless communication between the AMR 6 and the access point 19.

The system controller 16 acquires both the location of the AMR 6 and the location of the communication terminal 5. The system controller 16 transmits the location information of the AMR 6 and the location information of the communication terminal 5 to the AMR 6. The AMR 6 monitors the location of the communication terminal 5 and the location of the AMR 6. Further, the system controller 16 may monitor the location of the communication terminal 5 and the location of the AMR 6, separately from the AMR 6. The system controller 16 does not need to monitor the location of the communication terminal 5 and the location of the AMR 6.

In the location information system 34, the AMR 6 executes travel control in accordance with the flowchart of FIG. 7.

### Modification 4 of Location Information System

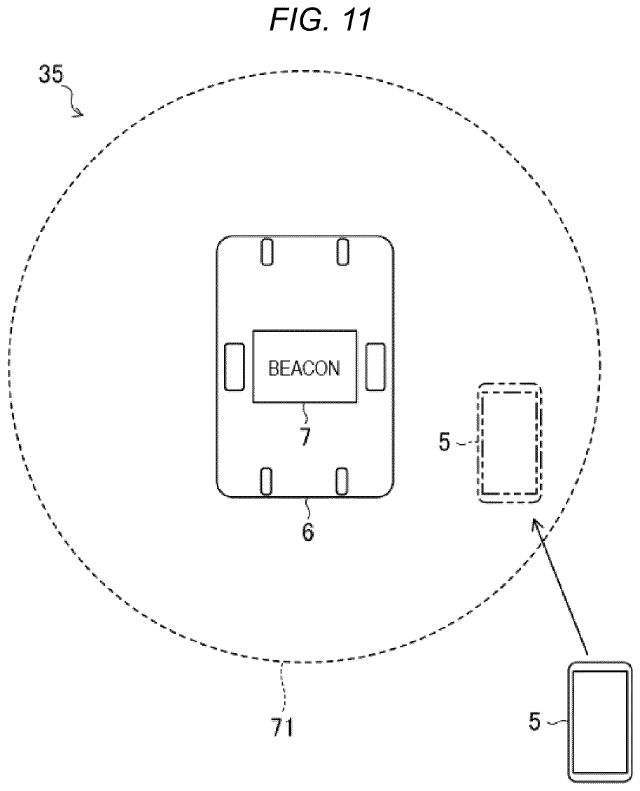

FIG. 11 illustrates a location information system 35 according to a modification. The location information system 35 includes a beacon 7 mounted on the AMR 6. The beacon 7 transmits Bluetooth radio waves in a specific radio wave range 71.

The communication terminal 5 cannot receive the Bluetooth radio waves transmitted from the beacon 7 outside the radio wave range 71, but can receive the Bluetooth radio waves transmitted from the beacon 7 when the communication terminal is within the radio wave range 71. The AMR 6 equipped with the beacon 7 can acquire the approach information between the AMR 6 and the person by using the short-range wireless communication. The AMR 6 equipped with the beacon 7 is an example of a location information providing portion that provides the AMR 6 with the approach information between a person and the AMR 6 as information regarding a location of a person in a specific area based on the short-range wireless communication with the communication terminal 5.

In the location information system 35, the AMR 6 executes travel control in accordance with the flowchart of FIG. 7.

### Other Modifications

The AMR 6 is not limited to the structure of FIG. 4. The AMR 6 may have omni-directional wheels, such as Mecanum wheels or omni wheels. Furthermore, the AMR 6 may be an AMR 6 having a steering mechanism, rather than an independently driven transport vehicle.

In the robot system 1, the system controller 16 may be omitted. The robot system 1 may achieve the above-mentioned control through mutual communication between the robot controller 17, the locator controller 18, and the AMR 6. In addition, the location information systems 31, 32, 33, and 34 may include a location information server instead of the system controller 16. The location information server acquires at least the location information of the communication terminal 5 based on the short-range wireless communication. The location information server is not limited to being installed in the plant where the robot system 1 is installed, and may be installed in the cloud.

Instead of the access points 19 that use Wi-Fi, beacons that use Bluetooth may be installed in various positions in the building 12.

The access point may be mounted on the AMR 6. The communication terminal 5 performs the short-range wireless communication with an access point mounted on the AMR 6. The access point of the AMR 6 may transmit Wi-Fi measurement information together with the location information of the AMR 6 to the system controller 16. Furthermore, the AMR 6 may determine the location of the communication terminal 5 based on Wi-Fi measurement information.

It should be noted that the work performed by the robot system 1 disclosed herein on the manufacturing line 10 is not limited to welding. Furthermore, the workpiece that the robot system 1 acts on is not limited to the body 11 of the automobile. Furthermore, the application of the robot system 1 is not limited to the automobile manufacturing line 10.

Furthermore, the location information systems 31, 32, 33, 34, and 35 disclosed herein are not limited to application in manufacturing plants. The location information systems 31, 32, 33, 34, and 35 can also be applied to, for example, a logistics warehouse where the AMR 6 travels.

The functions of the elements disclosed herein may be performed using circuits or processing circuits including general purpose processors, dedicated processors, integrated circuits, application specific integrated circuits (ASICs), circuits in the related art, and/or combinations thereof, configured or programmed to perform the disclosed functions. A processor is considered to be a processing circuit or circuit because the processor contains transistors and other circuits. In this disclosure, a circuit, unit, or means is hardware that performs the recited functions, or hardware that is programmed to perform the recited functions. The hardware may be the hardware disclosed herein or other known hardware that is programmed or configured to perform the recited functions. In a case where the hardware is a processor which can be considered as a type of circuit, the circuit, means, or unit is a combination of hardware and software, and the software is used to configure the hardware and/or the processor.

### Aspects

The above-described embodiments are specific examples of the following aspects.

### Aspect 1

A location information system (31, 32, 33, 34, 35) including: an autonomous mobile robot (6) that has map data (661) of a specific area (12) and a sensor (65) configured to estimate a location of a vehicle by detecting surrounding condition and that is configured to travel in the specific area (12); a communication terminal (5) to be carried by a person in the specific area (12); and a location information providing portion (16, 7) that is configured to provide the autonomous mobile robot (6) with information regarding a location of the person based on short-range wireless communication with the communication terminal (5).

The location information system (31, 32, 33, 34, 35) manages the location of the person and the location of the autonomous mobile robot (6) based on the short-range wireless communication, thereby reducing contact between the person and the autonomous mobile robot (6). The location information system (31, 32, 33, 34, 35) can improve safety in the specific area where the person and the autonomous mobile robot (6) coexist. That is, since information regarding the location of the person is provided to the autonomous mobile robot, the location information system can ensure safety in a specific area where the person and the autonomous mobile robot exist.

### Aspect 2

The location information system (32) according to aspect 1, in which the autonomous mobile robot (6) is configured to provide the estimated location of the autonomous mobile robot (6) to the location information providing portion (16).

The autonomous mobile robot (6) can determine the location of the vehicle using the map data (661) and the sensor (65). The location information system (32) can manage the location of the person and the location of the autonomous mobile robot (6) based on the location of the autonomous mobile robot (6) determined by the autonomous mobile robot (6). By using a function of the autonomous mobile robot (6), a configuration of the location information system (32) is made simple.

### Aspect 3

The location information system (33) according to aspect 1, in which the location information providing portion (16) is configured to provide the autonomous mobile robot (6) with location information of the communication terminal (5) as location information of the person, and the autonomous mobile robot (6) is configured to determine a relative location between the person and the autonomous mobile robot (6) based on the location information of the person and the estimated location of the autonomous mobile robot (6).

The autonomous mobile robot (6) can receive the location information of the person from the location information providing portion (16). The autonomous mobile robot (6) can manage the location of the person and the location of the vehicle.

### Aspect 4

The location information system (31, 34) according to aspect 1, in which the autonomous mobile robot (6) is capable of short-range wireless communication, and the location information providing portion (16) is configured to acquire location information of the person based on the short-range wireless communication with the communication terminal (5), and configured to acquire location information of the autonomous mobile robot (6) based on the short-range wireless communication with the autonomous mobile robot (6).

By using the short-range wireless communication, the location information system (31, 34) can acquire location information of both the location of a person and the location of the autonomous mobile robot (6) in the specific area (12).

### Aspect 5

The location information system (31, 32) according to aspect 2 or aspect 4, in which the location information providing portion (16) is configured to provide the autonomous mobile robot (6) with information regarding the relative location between the person and the autonomous mobile robot (6).

The autonomous mobile robot (6) can reduce contact with the person based on the information regarding the relative location between the person and the autonomous mobile robot (6).

### Aspect 6

The location information system (34) according to aspect 4, in which the location information providing portion (16) is configured to provide the autonomous mobile robot (6) with location information of the communication terminal (5) as the location information of the person and the location information of the autonomous mobile robot (6), and the autonomous mobile robot (6) is configured to determine the relative location between the person and the autonomous mobile robot (6) based on the location information of the person and the location of the autonomous mobile robot (6).

The autonomous mobile robot (6) can reduce contact with the person based on the information regarding the relative location between the person and the autonomous mobile robot (6).

### Aspect 7

The location information system (35) according to aspect 1, in which the location information providing portion (7) is mounted on the autonomous mobile robot (6), and is configured to provide the autonomous mobile robot (6) with approach information between the person and the autonomous mobile robot (6) based on the short-range wireless communication with the communication terminal (5).

The autonomous mobile robot (6) equipped with the location information providing portion (7) can acquire the approach information based on the short-range wireless communication with the communication terminal (5). The location information system (35) has a simple configuration.

### Aspect 8

The location information system (31, 32, 33, 34, 35) according to any one of aspects 1 to 7, in which the autonomous mobile robot (6) is configured to decelerate when the person and the autonomous mobile robot (6) approach each other.

By decelerating the autonomous mobile robot (6), contact between the person and the autonomous mobile robot (6) is reduced.

### Aspect 9

The location information system (31, 32, 33, 34, 35) according to any one of aspects 1 to 8, in which the autonomous mobile robot (6) is configured to stop when the person and the autonomous mobile robot (6) approach each other.

By stopping the autonomous mobile robot (6), contact between the person and the autonomous mobile robot (6) is reduced.

What is claimed is:

1. A location information system comprising:
an autonomous mobile robot that has map data of a specific area and a sensor configured to estimate a location of a vehicle by detecting surrounding condition and that is configured to travel in the specific area;
a communication terminal to be carried by a person in the specific area; and
a location information providing portion that is configured to provide the autonomous mobile robot with information regarding a location of the person based on short-range wireless communication with the communication terminal.

2. The location information system according to claim 1, wherein
the autonomous mobile robot is configured to provide the estimated location of the autonomous mobile robot to the location information providing portion.

3. The location information system according to claim 1, wherein
the location information providing portion is configured to provide the autonomous mobile robot with location information of the communication terminal as location information of the person, and
the autonomous mobile robot is configured to determine a relative location between the person and the autonomous mobile robot based on the location information of the person and the estimated location of the autonomous mobile robot.

4. The location information system according to claim 1, wherein
the autonomous mobile robot is capable of short-range wireless communication, and
the location information providing portion is configured to acquire location information of the person based on the short-range wireless communication with the communication terminal, and configured to acquire location information of the autonomous mobile robot based on the short-range wireless communication with the autonomous mobile robot.

5. The location information system according to claim 1, wherein
the location information providing portion is configured to provide the autonomous mobile robot with information regarding a relative location between the person and the autonomous mobile robot.

6. The location information system according to claim 4, wherein
the location information providing portion is configured to provide the autonomous mobile robot with the location information of the communication terminal as the location information of the person and the location information of the autonomous mobile robot, and
the autonomous mobile robot is configured to determine a relative location between the person and the autonomous mobile robot based on the location information of the person and the location of the autonomous mobile robot.

7. The location information system according to claim 1, wherein
the location information providing portion is mounted on the autonomous mobile robot, and is configured to provide the autonomous mobile robot with approach information between the person and the autonomous mobile robot based on the short-range wireless communication with the communication terminal.

8. The location information system according to claim 1, wherein
the autonomous mobile robot is configured to decelerate when the person and the autonomous mobile robot approach each other.

9. The location information system according to claim 1, wherein
the autonomous mobile robot is configured to stop when the person and the autonomous mobile robot approach each other.
